(19) United States
(12) Patent Application Publication
(10) Pub. No.: US 2023/0278646 A1
(43) Pub. Date: Sep. 7, 2023

(54) METHOD FOR PRODUCING A BODY COMPONENT OF A VEHICLE BODY OF A VEHICLE, AND BODY COMPONENT AND VEHICLE BODY

(71) Applicant: 3M INNOVATIVE PROPERTIES COMPANY, St. Paul, MN (US)

(72) Inventors: Elisabeth CURA, Düsseldorf (DE); Nurettin YAVUZ, Düsseldorf (DE); Robert HERMSDORF, Krefeld (DE)

(21) Appl. No.: 18/005,685

(22) PCT Filed: Jul. 16, 2021
(86) PCT No.: PCT/IB2021/056456

§ 371 Date: Jan. 17, 2023

(30) Foreign Application Priority Data
Jul. 17, 2020 (DE) 10 2020 118 934.6

(51) Int. Cl. B62D 27/02; B62D 29/00

(52) U.S. Cl. CPC B62D 27/026; B62D 29/008

(57) ABSTRACT

The present invention relates to a method for producing a body component (1) of a vehicle body (21) of a vehicle (20), wherein the method has the steps of:
(a) providing a structural part (2) of the body component (1) provided with adhesive film (4), wherein the adhesive film (4) is applied to at least one adhesive surface (6) of the structural part (2),
(b) providing a further part (3) of the body component (1),
(c) applying an adhesive (5) to the adhesive film (4), and
(d) adhesively bonding the structural part (2) provided with adhesive film (4) to the further part (3) by means of the adhesive (5) applied to the adhesive film (4), so that the body component (1) is obtained as the structural part (2) adhesively bonded to the further part (3) and provided with adhesive film (4).

The invention further relates to a body component (1) of a vehicle body (21) of a vehicle (20), as well as to a vehicle body (21) of a vehicle (20) having at least one such body component (1).

The present invention relates to a method for producing a body component of a vehicle body of a vehicle, as well as to a body component having a structural part and a further part adhesively bonded thereto, and also to a vehicle body having the body component.

In particular, aluminum parts as structural parts of body components have the disadvantage that, after their production, they can only be stored in the oxygen-rich atmosphere or environment for a certain holding time before they oxidize. The aluminum oxide layer forming during oxidation results in disadvantageous properties of the surfaces of the structural part. In particular, the surfaces of the structural part lose adhesiveness. For safety-critical structural parts of body components, a component surface of an aluminum part having an aluminum oxide layer can no longer be adhesively bonded to a further part in a sufficiently reliable and secure manner.

Therefore, in the prior art, in the production of body components of vehicle bodies consisting of a structural part and a further part which are adhesively bonded to one another, the structural part is dip-coated before adhesive bonding with the further part in order to obtain the specific surface properties of the structural part. In the case of an aluminum part, oxidation of the surfaces is thus avoided, and the good adhesion properties of the surfaces of the aluminum part are obtained for subsequent adhesive bonding to the further part.

Obtaining the surface properties by dip coating the structural part is very effective, but also time-consuming and cost-intensive. In this case, the dip coating of the assembled vehicle (unfinished) body in which the body component is used is in any case carried out at the vehicle manufacturer at the latest. As a result, the structural part is dip-coated twice, viz., once before adhesive bonding to the further part and once after assembling the vehicle (unfinished) body. Not only is this process redundant, and therefore also cost-intensive, it also has an additional impact on the environment due to the chemical substances necessary for the dip coating in the dip baths required for this purpose.

However, due to the short holding time until oxidation for an aluminum structural part, the dip coating cannot, in the prior art, be omitted from the production process, since it is not easy to avoid exceeding the holding time until the structural part is adhesively bonded to the further part. In addition, the structural part is usually manufactured by a supplier external to the vehicle manufacturer and is supplied to the vehicle manufacturer for adhesive bonding to the further part or for producing the body component. The vehicle manufacturer then assembles the body component by adhesive bonding. Only thereafter does it assemble the entire vehicle body with the body component and perform the dip coating. A lot of time passes before the vehicle manufacturer adhesively bonds the structural part to the further part, not least due to the transport from the supplier to the vehicle manufacturer. The holding time of the structural part cannot be maintained, and the aluminum structural part would oxidize and lose its good adhesion properties without prior dip coating.

It is therefore the aim of the present invention to reduce the disadvantages described above in the production of a body component from a structural part and a further part—in particular, to provide a method for producing a body component of a vehicle body of a vehicle which satisfies the requirements of the vehicle body, such as crash safety, body stiffness, etc., in a cost-effective and environmentally friendly manner.

The above aim is achieved by a method for producing a body component of a vehicle body of a vehicle having the features of claim 1, as well as by a body component having the features of claim 12 and by a vehicle body having the features of claim 15. Further features and details of the invention can be found in the dependent claims, the description, and the drawings. Features and details described in connection with the method according to the invention naturally also apply in connection with the body component according to the invention as well as the vehicle body according to the invention, and vice versa, and, therefore, with regard to the disclosure of the individual aspects of the invention, reference is or can always be made reciprocally.

According to the first aspect of the invention, the aim is achieved by a method for producing a body component of a vehicle body of a vehicle, wherein the method has the steps of:
(a) providing a structural part of the body component provided with adhesive film, wherein the adhesive film is applied to at least one adhesive surface of the structural part,
(b) providing a further part of the body component,
(c) applying an adhesive to the adhesive film, and
(d) adhesively bonding the structural part provided with adhesive film to the further part by means of the adhesive applied to the adhesive film, so that the body component is obtained as the structural part adhesively bonded to the further part and provided with adhesive film.

The method according to the invention thus achieves secure adhesive bonding of the structural part to the further part in order to produce the body components, without the structural part having to be additionally dip-coated beforehand. The adhesive film is used instead of the dip coating to provide good adhesion properties for the adhesive bonding to the further part. Thus, the further part is no longer adhesively bonded to the at least one adhesive surface of the structural part itself, but to the adhesive film or to a surface of the adhesive film at the position of the at least one adhesive surface, by means of the adhesive. This ensures a reduction in the costs of preparing the structural part for producing the body component, and thus the costs of producing the vehicle body overall. In addition, it improves the environmental balance of the production of the body components, and thus of the vehicle body, since the dip coating of only the structural part can be omitted.

The at least one adhesive surface can comprise at least two or more adhesive surfaces. In particular, the structural part can have three to thirty—further, in particular, five to twenty—adhesive surfaces. Typically, the structural part can have around ten adhesive surfaces.

The adhesive can be applied to the entire surface of the adhesive film or to a partial surface of the adhesive film, for adhesively bonding the structural part to the further part.

The provision of the structural part can comprise the production of the structural part. Furthermore, the provision of the further part can comprise the production of the further part.

The structural part can consist of a metal or be metallic. Furthermore, the further part can consist of a metal or be metallic. The further part can be, for example, a steel sheet. In the form of a steel sheet, it can, for example, form a panel of the vehicle body. However, the further part can also be, for example, a composite material made of a plastic or the like.

It can be provided for the structural part to be an aluminum part. In other words, the structural part can consist of aluminum or an aluminum alloy, or at least contain aluminum. With the aluminum part, the holding time is short before the surface properties change—in particular, the adhesion properties are reduced due to oxidation.

In this case, it can be provided for at least one surface, exposed to the environment, of the structural part provided with adhesive film to oxidize, so that an aluminum oxide layer forms or enlarges on the at least one exposed surface. The at least one exposed surface is the surface of the structural part on which no adhesive film is arranged or which is not an adhesive surface. In contrast, adhesive surfaces are only the surfaces which are provided for adhesive bonding to the further part. Accordingly, there can also be several exposed surfaces on the structural part. The at least one exposed surface oxidizes, since it is exposed to the oxygen-rich environment. Since the at least one exposed surface is not used for adhesively bonding the structural part to the further part, protecting the exposed surface from oxidation, i.e., for example, likewise providing it with adhesive film or coating it, as in the prior art, can be deliberately omitted. The good adhesion properties of the structural part during the holding time are thus deliberately foregone on the at least one exposed surface. Later, the at least one exposed surface of the structural part can also be coated together with the vehicle body or vehicle unfinished body in a dip bath.

In this case, it can be provided for the structural part to have no aluminum oxide layer on the at least one adhesive surface, or for the aluminum oxide layer on the at least one exposed surface of the structural part to be thicker than an aluminum oxide layer on the at least one adhesive surface. This can be achieved in that the adhesive film is adhered to the at least one adhesive surface directly or within a short time (for example, at most 3 hours—in particular, at most 1 hour or at most 30 minutes) after the production of the structural part or its storage in a low-oxygen or oxygen-free atmosphere. Very good adhesion properties of the adhesive film on the at least one adhesive surface can be achieved thereby, since said adhesive surface is not yet oxidized or is only slightly oxidized at the time of application of the adhesive film.

To provide the structural part provided with adhesive film, it can further be provided for the method to have the steps of providing the structural part and applying the adhesive film to the at least one adhesive surface of the structural part provided, so that the structural part provided with adhesive film is obtained. The adhesive film can, in particular, be applied by machine and, further, particularly in an automated manner—for example, by a robot. While the adhesive bonding of the further part to the structural part can take place at the manufacturer of the vehicle body or at the vehicle manufacturer of the vehicle, the production and/or application of the adhesive film can take place at a supplier.

In this case, the adhesive film can be provided as tape material and applied to the at least one adhesive surface of the structural part. The adhesive film can, in particular, be applied by machine and, further, particularly in an automated manner—for example, by a robot. Accordingly, the adhesive film in the form of tape material can be cut to fit the at least one adhesive surface or the several adhesive surfaces. The tape material can, for example, be unrolled from a roll. Alternatively, the adhesive film can be provided in the form of at least one blank for the at least one adhesive surface or in the form of blanks for the respective adhesive surfaces.

It can also be provided for the adhesive film to be thermally cured after application to the at least one adhesive surface of the structural part. Accordingly, the adhesive film is then a thermally-curable adhesive. The thermal curing can take place, for example, in a furnace, or inductively.

In addition, it can be provided for the adhesive to be an adhesive in paste form—in particular, a 1-component adhesive in paste form. The adhesive can be an adhesive that differs from the adhesive film or has a different chemical composition or base. Accordingly, a body adhesive known per se can be selected as the adhesive.

It can also be provided for the at least one adhesive surface to be uncoated. In particular, it is possible for the structural part to be provided as an uncoated structural part or to be uncoated before the adhesive film is applied to the structural part. Protection against oxidation of the surfaces of the structural part is thus deliberately omitted in order to avoid the associated disadvantages, such as increased costs and environmental pollution, and to rely upon the adhesive film only.

It is then possible for the structural part—in particular, the body component—to be dip-coated—in particular, cathodically dip-coated—for the first time together with the vehicle body. Since the vehicle body or vehicle unfinished body is in this case completely immersed in one or more dip baths, the structural part is necessarily also coated on the exposed surfaces. By contrast, the adhesive surfaces remain covered with the adhesive film, to which the further part is in turn adhered. The adhesive surfaces are thus not coated.

It is also possible for there to be a time period of at least 12 hours—in particular, of at least 24 hours or of at least 48 hours—between the application of the adhesive film to the at least one adhesive surface of the structural part and the dip coating of the body component. As a result, the time period in-between can be used for transport. The adhesive film can thus be applied to the adhesive surfaces at the supplier, while the dip coating is carried out only after the transport and production of the vehicle body at the vehicle manufacturer.

The structural part can also be provided as an extruded profile or cast part. The structural part can then withstand high forces or deform only slightly with a corresponding application of force—for example, in the case of a crash.

Moreover, it can be provided for the adhesive film to comprise epoxy resin. In particular, the adhesive film can predominantly comprise epoxy resin, or, in other words, the adhesive film can be epoxy-based.

Furthermore, it can be provided for the adhesive film to have two adhesive layers and a carrier layer arranged between the two adhesive layers. Such an adhesive film can also be referred to as a structural adhesive film. The adhesive layers can provide the adhesive effect. The carrier layer can hold the adhesive layers together and stiffen the adhesive film. The carrier layer can have a mesh structure. The carrier layer with mesh structure can consist, for example, of a woven fabric. In general, the adhesive film can be covered on the adhesive layers with a foil, which prevents undesired adhesive bonding. Only after the foil is pulled off does an open time of the adhesive start, or can the adhesive film be adhered to the structural part.

According to a second aspect of the invention, the aim is achieved by a body component of a vehicle body of a vehicle, wherein the body component has a structural part of the vehicle body and a further part of the vehicle body, wherein an adhesive film is arranged between the structural part and the further part, and wherein an adhesive which holds the structural part and the further part together is arranged on the adhesive film.

Thus, the body component according to the second aspect of the invention has the same advantages as those described in detail with respect to the method according to the first aspect of the invention.

It can be provided for the body component to be produced by the method according to the first aspect of the invention.

It can also be provided for the structural part to be an aluminum part, the adhesive film to be arranged on at least one adhesive surface of the structural part of the adhesive film, and no adhesive film to be arranged on at least one exposed surface of the structural part, wherein the structural part has an aluminum oxide layer on the at least one exposed surface, and (a) the structural part does not have an aluminum oxide layer on the at least one adhesive surface or (b) does have an aluminum oxide layer on the at least one adhesive surface, but the aluminum oxide layer located on the exposed surface is thicker than the aluminum oxide layer on the at least one adhesive surface.

According to a third aspect of the invention, the aim is achieved by a vehicle body of a vehicle having at least one body component according to the second aspect of the invention.

A method according to the invention for producing a body component of a vehicle body, a body component according to the invention, and a vehicle body according to the invention are explained in more detail below by way of example and schematically, with reference to drawings. In the figures:

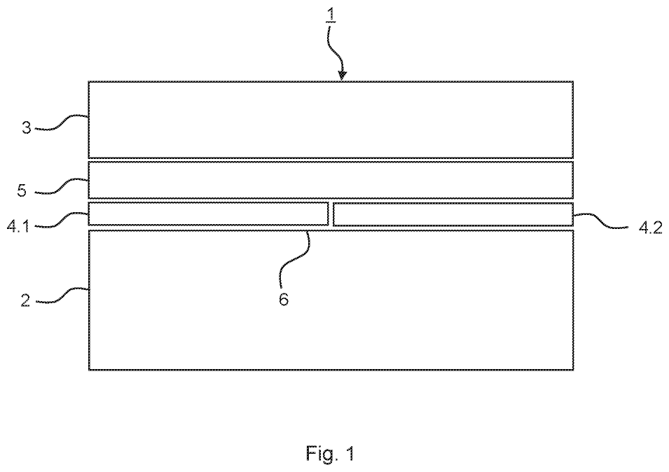

FIG. 1 shows a schematic diagram of a sectional view of a body component according to an exemplary embodiment of the invention,

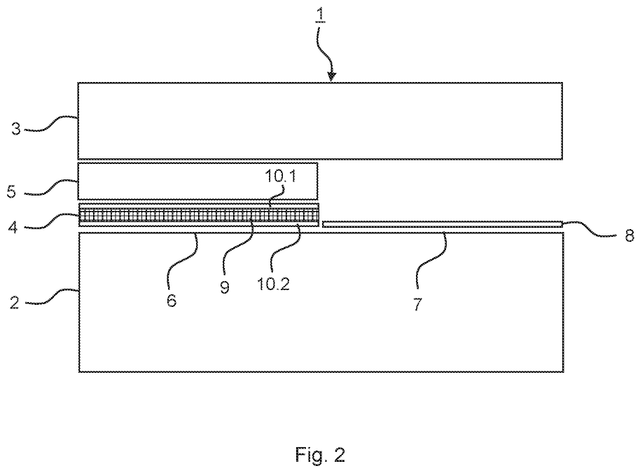

FIG. 2 shows a schematic diagram of a further sectional view of the body component from FIG. 1,

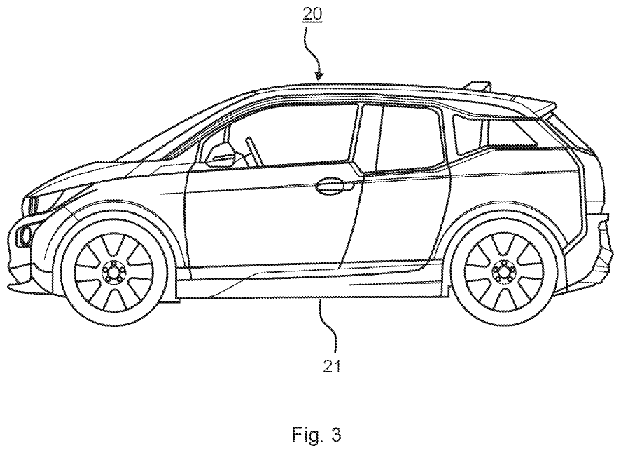

FIG. 3 shows a side view of a vehicle with a vehicle body according to an exemplary embodiment of the invention, and

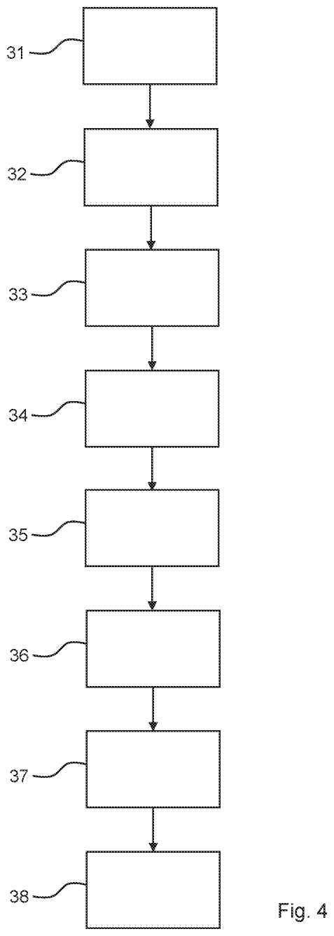

FIG. 4 shows a schematic diagram of the sequence of method steps in a method for producing the body component from FIGS. 1 and 2 according to an exemplary embodiment of the invention.

Elements with the same function and mode of operation are provided with the same reference symbols in FIGS. 1 through 4.

FIG. 1 schematically shows a section through a body component 1 for a vehicle body 21 of a vehicle 20 (see FIG. 3). The body component 1 can be arranged in the visible region of the vehicle body 21 or in the non-visible region of the vehicle body 21.

The cross-sectional view from FIG. 1 illustrates the parts of the body component 1 and an exemplary arrangement. The body component 1 has a structural part 2. In the present case, the structural part 2 is an aluminum part. The structural part 2 is a torsionally-rigid part, which ensures a high degree of rigidity in the body component 1 in order to meet crash safety requirements in the vehicle body 21.

The body component 1 also has a further part 3. The further part 3 is connected to the structural part 2 by an adhesive bond, as explained in more detail below. The adhesive bond must likewise meet the crash safety requirements of the vehicle body 21, i.e., withstand certain minimum loads without coming undone. The further part 3 can likewise be a structural part 2, e.g., made of aluminum, or can be a simpler part, such as a metal sheet, e.g., a steel sheet—in particular, a paneling sheet of the vehicle body 21.

The adhesive bond is designed in such a way that an epoxy-based adhesive film 4.1, 4.2 is applied to various adhesive surfaces 6 of the structural part 2—in the present case, for example, ten adhesive surfaces 6—wherein only the one adhesive surface 6 is labeled. In the present exemplary embodiment, the adhesive film 4.1, 4.2 is shown by way of example in two portions or adhesive film strips which have been unrolled from a tape material. However, the adhesive film 4 can also be only one adhesive film portion or strip, or more than two portions. In particular, one portion of the adhesive film 4 can be applied to one adhesive surface 6 in each case. There is, due to production, a tolerance gap between the portions of the adhesive film 4.1, 4.2. These portions of the adhesive film 4.1, 4.2 are thermally cured.

The adhesive film 4 has been applied to the adhesive surfaces 6 directly or promptly after the production of the structural part 2, so that the aluminum of the structural part 2 could not oxidize, or could only slightly oxidize, on the adhesive surfaces 6. A good adhesion effect between the adhesive film 4.1, 4.2 and the structural part 2 could be achieved thereby.

If an aluminum oxide layer 8 (see FIG. 2) had formed on the adhesive surfaces 6 or if the aluminum oxide layer 8 were relatively thick, the adhesion of the adhesive film 4.1, 4.2 thereon would be poor, and it would not be possible to fasten the further part 3 thereto by means of the adhesive 5 in such a way that the crash safety requirements could be met.

In contrast, the adhesive film 4.1, 4.2 adheres well to the structural part 2 and continues to provide good adhesion properties for adhesively bonding the structural part 2 to the further part 3 at the surface of the adhesive film 4.1, 4.2. As a result, the structural part 2 was adhesively bonded to the further part 3 by means of the adhesive film 4.1, 4.2 and the adhesive 5 arranged thereon - in the present case, a 1-component adhesive. The body component 1 produced in this way, which in turn can be assembled with or joined to further body components 1 of the vehicle body 21, thus fulfills the necessary crash requirements with regard to the joining connection between the structural part 2 and the further part 3.

Unlike in the prior art, the structural part 2 does not have to be dip-coated separately before being joined to the further part 3. The structural part 2 can also be obtained from a supplier and joined to the further part 3 only at the body manufacturer or vehicle manufacturer, since the aluminum of the structural part 2 cannot oxidize on the adhesive surfaces 6. Instead, the surface of the adhesive film 4 is used for adhesive bonding to the further part 3 by means of the adhesive 5. Furthermore, the structural part 2 can then later be dip-coated together with the entire vehicle body 21 in a cathodic dip bath.

FIG. 2 shows an alternative cross-sectional view of the body component 1 from FIG. 1. FIG. 2 shows that, in addition to the adhesive surfaces 6, there are also, on the structural part 2, surfaces 7 exposed to the environment. These exposed surfaces 7 are not provided with adhesive film 4 and are also not dip-coated. The exposed surfaces 7 therefore oxidize on the way from the supplier to the vehicle manufacturer, as a result of which an aluminum oxide layer 8 forms on the exposed surfaces 7. However, this is not disadvantageous for the adhesion of the structural part 2 to the further part 3, since the structural part 2 is adhesively bonded to the further part 3 only at the surfaces of the adhesive film 4 which cover the adhesive surfaces 6. There, the adhesion properties are better than on the aluminum oxide layer 8 on the exposed surfaces 7, due to the adhesive film 4.

FIG. 2 also shows the structure of the adhesive film 4. The adhesive film 4 has a mesh-like carrier layer 9 with an adhesive layer 10.1, 10.2 located below and above it. This structure of the adhesive film 4 ensures good adhesion to the structural part 2, as well as good adhesion for the adhesive 5.

FIG. 4 schematically shows a sequence of the method steps in a method for producing the body component 1 from FIGS. 1 and 2, as is used in the vehicle body 21 from FIG. 3.

In a first method step 31, the structural part 2 is produced. This production of the structural part 2 can be carried out by a supplier of the manufacturer of the vehicle body 21 or of the vehicle manufacturer of the vehicle 20. For example, the structural part 2 can be produced as an aluminum extruded profile by extrusion molding. Alternatively, the structural part 2 can be produced as a cast part by means of casting.

In the second method step 32, the adhesive film 4, which is provided as tape material, is applied to the adhesive surfaces 6 of the structural part 2. This takes place immediately after or shortly after the production of the structural part 2, so that no, or at most the smallest possible, aluminum oxide layer 8 is formed on the adhesive surfaces 6. This makes it possible to ensure good adhesion of the adhesive film 4 to the adhesive surfaces 6. Accordingly, this second method step 32 is preferably likewise carried out by the supplier.

In the third method step 33, the adhesive film 4 is thermally cured. This can take place, for example, in a furnace into which the structural part 2 provided with adhesive film 4 is introduced. Alternatively, this can be done by inductive and local heating at the adhesive surfaces 6.

In the fourth method step 34, the structural part 2 with the thermally-cured adhesive film 4 is transported and provided to the manufacturer of the vehicle body 21 or the vehicle manufacturer of the vehicle 20. A long period of time can pass here. In the process, the exposed surface 7 on the structural part 2 can oxidize. However, since the adhesive surfaces 6 on the structural part 2 are provided with the cured adhesive film 4, the structural part 2 continues to have a good adhesion effect, viz., on the cured adhesive film 4 on the adhesive surfaces 6.

In the fifth method step 35, the further part 3 of the body component 1 is provided at the manufacturer of the vehicle body 21 or the vehicle manufacturer of the vehicle 20, which in turn can originate from another supplier.

In the sixth method step 36, the structural part 2 is adhesively bonded to the further part 3 on the adhesive film 4 by means of the adhesive 5. The body component 1 is thus obtained as the structural part 2 adhesively bonded to the further part 3 and provided with adhesive film 4.

In the seventh method step 37, the body component 1 consisting of structural part 2 and further part 3 is then connected to further components to form the vehicle body 21.

Finally, in the eighth method step 38, cathodic dip coating of the vehicle body 21 with the body component 1 takes place in one or more dip baths. In the process, the aluminum oxide layer 8, which has formed in the meantime on the exposed surfaces 7, is coated as well. This constitutes the first coating of the exposed surfaces 7 of the structural part 2.

### LIST OF REFERENCE SYMBOLS

1 Body component
2 Structural part
3 Further part
4 Adhesive film
5 Adhesive
6 Adhesive surface
7 Exposed surface
8 Aluminum oxide layer
9 Carrier layer
10 Adhesive layer
20 Vehicle
21 Vehicle body
31 . . . 38 Method steps

1. Method for producing a body component (1) of a vehicle body (21) of a vehicle (20), wherein the method has the steps of:
(a) providing a structural part (2) of the body component (1) provided with adhesive film (4), wherein the adhesive film (4) is applied to at least one adhesive surface (6) of the structural part (2),
(b) providing a further part (3) of the body component (1),
(c) applying an adhesive (5) to the adhesive film (4), and
(d) adhesively bonding the structural part (2) provided with adhesive film (4) to the further part (3) by means of the adhesive (5) applied to the adhesive film (4), so that the body component (1) is obtained as the structural part (2) adhesively bonded to the further part (3) and provided with adhesive film (4).

2. Method according to claim 1, wherein the structural part (2) is an aluminum part.

3. Method according to claim 2, wherein at least one surface (7), exposed to the environment, of the structural part (2) provided with adhesive film (4) oxidizes, so that an aluminum oxide layer (8) forms or enlarges on the at least one exposed surface (7).

4. Method according to one of the preceding claims claim 1, wherein, to provide the structural part (2) provided with adhesive film (4), the method further has the steps of providing the structural part (2) and applying the adhesive film (4) to the at least one adhesive surface (6) of the structural part (2) provided, so that the structural part (2) provided with adhesive film (4) is obtained.

5. Method according to claim 4, wherein the adhesive film (4) is thermally cured after application to the at least one adhesive surface (6) of the structural part (2).

6. Method according to claim 4, wherein the adhesive film (4) is provided as tape material and is applied to the at least one adhesive surface (6) of the structural part (2).

7. Method according to claim 1, wherein the adhesive is, a 1 component adhesive in paste form.

8. Method according to claim 1, wherein the at least one adhesive surface (6) is uncoated.

9. Method according to claim 1, wherein the structural part (2) is provided as an extruded profile or cast part.

10. Method according to claim 1, wherein the adhesive film (4) comprises epoxy resin.

11. Method according to claim 1, wherein the adhesive film (4) has two adhesive layers (10.1, 10.2) and a carrier layer (9) arranged between the two adhesive layers (10.1, 10.2).

12. Body component (1) of a vehicle body (21) of a vehicle (20), wherein the body component (1) has a structural part (2) of the vehicle body (21) and a further part (3) of the vehicle body (21), wherein an adhesive film (4) is arranged between the structural part (2) and the further part (3), and wherein an adhesive (5) which holds the structural part (2) and the further part (3) together is arranged on the adhesive film (4).

13. Body component (1) according to claim 1, wherein the body component (1) is produced according to a method of claim 1.

14. Body component (1) according to claim 12, wherein the structural part (2) is an aluminum part, the adhesive film (4) is arranged on at least one adhesive surface (6) of the structural part (2), and no adhesive film (4) is arranged on at least one exposed surface (7) of the structural part (2), wherein the structural part (2) has an aluminum oxide layer (8) on the at least one exposed surface (7), and
(a) the structural part (2) does not have an aluminum oxide layer (8) on the at least one adhesive surface (6), or
(b) does have an aluminum oxide layer (8) on the at least one adhesive surface (6), but the aluminum oxide layer (8) located on the exposed surface (7) is thicker than the aluminum oxide layer (8) on the at least one adhesive surface (6).

15. Vehicle body (21) of a vehicle (20) having at least one body component (1) according to claim 12.
